(19) United States
(12) Patent Application Publication
(10) Pub. No.: US 2014/0333125 A1
(43) Pub. Date: Nov. 13, 2014

(54) SPROCKET WITH REPLACEABLE TEETH

(71) Applicant: CATERPILLAR INC., Peoria, IL (US)

(72) Inventor: Timothy R. Hoyt, Dunlap, IL (US)

(73) Assignee: Caterpillar Inc., Peoria, IL (US)

(21) Appl. No.: 13/890,606

(22) Filed: May 9, 2013

(51) Int. Cl. B62D 55/125; B62D 55/32

(52) U.S. Cl. CPC B62D 55/125; B62D 55/32
USPC 305/199; 29/893

(57) ABSTRACT

A sprocket assembly may include a hub and a plurality of circumferentially spaced projections extending radially outward from the hub. The sprocket assembly may also include a plurality of teeth, each tooth being carried by one of the projections and having a recess that receives said projection therein. The projections and the recess in the teeth may have complimentary geometry to provide a close fit.

### TECHNICAL FIELD

The present disclosure relates generally to a sprocket having individually replaceable teeth. More particularly, the present disclosure relates to a sprocket adapted for use in the undercarriage of a tracked vehicle, the sprocket having teeth that are each independently and selectively removable from a hub.

### BACKGROUND

Earthmoving and construction vehicles often include a tracked undercarriage system for support and propulsion. These undercarriage systems may include a drive member operatively connected to a drive sprocket to transfer power to a track chain. The track chain may be movably routed around the sprocket, at least one idler and one or more rollers so that rotation of the sprocket causes the track chain to travel around the idler and rollers, thereby causing propulsion of the vehicle.

The track chain may include laterally spaced links connected to adjacent links by pins that extend laterally between the links. The sprocket of the track chain assembly is adapted to engage and drive the track chain assembly, and may include teeth that engage the pins extending between links of the track chain. These sprockets can be formed from a single member with integral teeth extending radially outwardly. Alternatively, these sprockets can include a circular hub member adapted to support a plurality of toothed sprocket segments. Sprockets of the type used in undercarriage systems are subjected to relatively high forces and abrasive environments, and as a result have a limited life. Maintenance or replacement of the above described sprocket types may result in a high volume of material cost due to the need to replace portions of the hub that are not prone to wear.

It has also been previously contemplated that a hub member may be adapted to accommodate a plurality of separate individual teeth. For example, U.S. Pat. No. 4,752,281 discloses a drive sprocket assembly for driving an endless chain assembly including a support hub mountable to the power output portion of the vehicle and a plurality of replaceable teeth mountable to the hub. However, the drive sprocket disclosed by the U.S. Pat. No. 4,752,281, and other previously contemplated drive sprockets with separate individual teeth, suffer from disadvantages. For example, known drive sprockets with separately removable and replaceable teeth may be complicated, difficult to manufacture and/or assemble and may be less reliable than single piece drive sprockets or drive sprockets incorporating sprocket segments.

The method and/or apparatus of the present disclosure alleviates one or deficiencies of the prior art.

### SUMMARY OF THE INVENTION

One aspect of the present disclosure is directed to a sprocket assembly comprising: a hub; a plurality of circumferentially spaced projections extending radially outward from the hub; and a plurality of teeth, each tooth being carried by one of the projections and having a recess that receives said projection therein.

Another aspect of the present disclosure is directed to a sprocket tooth comprising: a base including a lower surface; a boss extending from the base and having a longitudinal axis; first and second flank surfaces, each flank surface facing generally outward from the longitudinal axis of the boss; and a recess portion extending from the lower surface of the base and defining a recess, the recess portion configured to receive a projection extending from a hub.

Another aspect of the present disclosure is directed to a method of replacing a tooth on a sprocket comprising the steps of: releasing a retaining mechanism to allow removal of a worn tooth having an internal recess from a projection extending radially outward from a hub; removing the worn tooth from the projection; positioning a new tooth having an internal recess over the projection so that the projection is received within the recess; and activating the retaining mechanism to prevent removal of the new sprocket tooth from the projection.

### BRIEF DESCRIPTION OF THE DRAWINGS

FIG. 1 is side view of an exemplary tractor having a sprocketed drive assembly including a continuous chain assembly;

FIG. 2 is a section view illustrating an exemplary portion of the sprocketed drive assembly of FIG. 1;

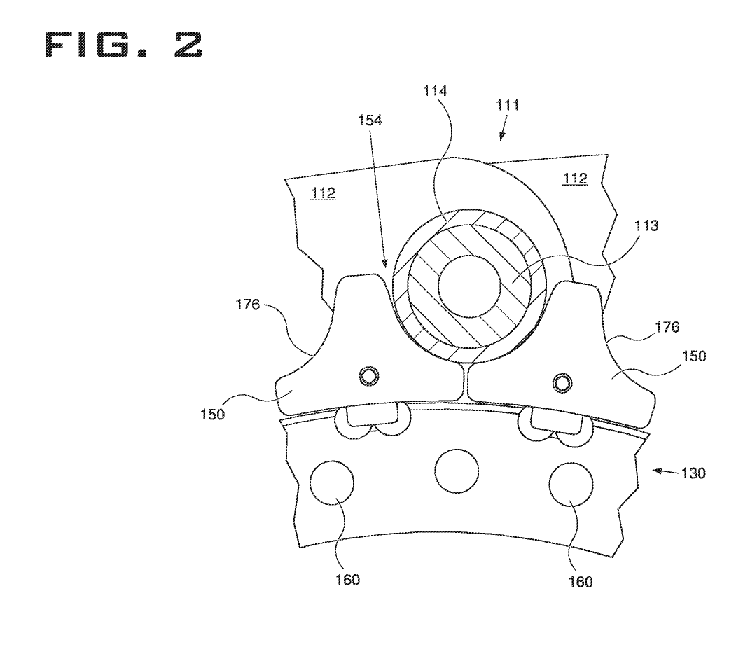

FIG. 3 is a perspective view of a drive sprocket assembly according to the concepts of the present disclosure;

FIG. 4 is side view of the drive sprocket assembly of FIG. 3;

FIG. 5 is a fragmentary side view of the drive sprocket assembly including a hub, a mounting projection, a tooth and a retention mechanism;

FIG. 6 is a fragmentary exploded perspective view of the drive sprocket assembly according to the concepts of the present disclosure;

FIG. 7 is a fragmentary perspective view of a portion of the hub of FIG. 6 including a mounting projection;

FIG. 8 is a fragmentary side view of the portion of the hub depicted in FIG. 7;

FIG. 9 is a perspective view of a sprocket tooth according to the concepts of the present disclosure;

FIG. 10 is a top view of the sprocket tooth of FIG. 9;

FIG. 11 is a bottom view of the sprocket tooth of FIG. 9;

FIG. 12 is a side view of the sprocket tooth of FIG. 9;

FIG. 13 is a section view of the sprocket tooth taken generally along line 13-13 of FIG. 13; and

FIG. 14 is a section view of a portion of the sprocket assembly taken generally along line 14-14 of FIG. 5.

### DETAILED DESCRIPTION

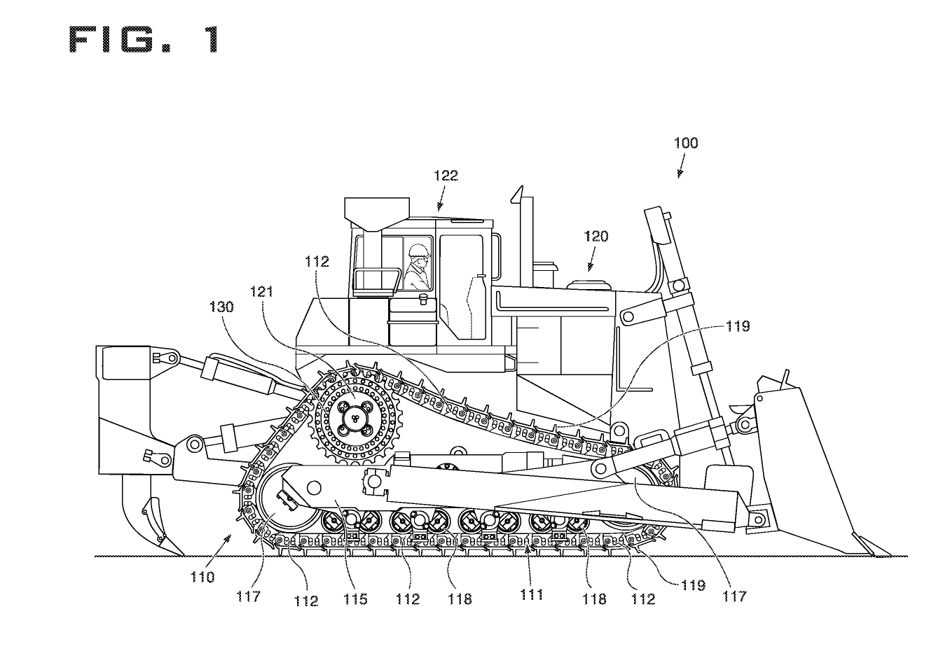

Referring now to FIG. 1, an exemplary track-type machine is shown and is indicated generally by the numeral 100. The track-type machine 100 may embody any machine that is driven, propelled, positioned, and/or maneuvered by operating a “continuous” track-type traction device. These machines may include, for example, track-type tractors, skid steers, dozers, excavators, backhoes, track loaders, front shovels, or any other type of track-maneuverable machine. Track-type machine 100 may include a ground-engageable track assembly 110 and a drive mechanism 120 (e.g. an engine) operatively engaged with track assembly 110 through a drive sprocket assembly 130. Track assembly 110 may be configured to propel track-type machine 100 when driven by drive mechanism 120.

Track assembly 110 may include a plurality of components that form the “continuous” track portion of the drive system of machine 100. Track assembly 110 may include, among other things, a chain assembly 111 having a plurality of interlocking link members 112, a roller frame assembly 115, at least one idler 117, and a plurality of rollers 118. The components of track assembly 110 listed above are exemplary only and not intended to be limiting. Accordingly, it is contemplated that track assembly 110 may include additional and/or different components than those listed above. For example, track assembly 110 may also include a plurality of track shoes 119, which may be affixed to each of link members 112 to provide protective, treaded covering for link members 112.

As indicated above, chain assembly 111 may comprise a plurality of link members 112 that are coupled together to form a continuous ground-engaging track chain. For example, adjacent (e.g. consecutive) link members may be coupled together via a plurality of pin members 113, each pin member having a bushing 114 disposed thereon. Bushing 114 may be engaged by drive sprocket assembly 130, which is operatively coupled to drive mechanism 120. When rotated by drive mechanism 120, drive sprocket assembly 130 may force chain assembly 111 to move in the direction of rotation of drive sprocket assembly 130.

Roller frame assembly 115 may include one or more axles and/or any other suitable structure for supporting a substantial portion of the weight of machine 100. According to one embodiment, roller frame assembly 115 may embody the primary frame or chassis of machine 100, upon which many of the components (e.g., drive mechanism 120, operator cab 122, etc.) of machine 100 may be mounted and secured. It is contemplated that track-type machine 100 may include multiple roller frame assemblies and, according to one embodiment, may comprise a roller frame assembly 115 for each track assembly 110 associated with machine 100. An idler hub 116 may be mounted to the roller frame assembly 115 at one or both of a front and rear of the track-type machine, the idler hub 116 configured to receive thereon idler 117, which helps to guide the chain assembly 111.

Roller frame assembly 115 may be configured to carry the rollers 118 that cooperate to provide a platform upon which roller frame assembly 115 may roll during movement of track-type machine 100. Rollers 118 may embody any suitable type of heavy-duty wheel that may be configured to interact with chain assembly 111 so as to guide and position chain assembly 111 as it travels around roller frame assembly 115. In a particular embodiment, rollers 118 may be affixed to a bottom portion of roller frame assembly 115 such that a portion of each of rollers 118 travels atop bushings 114 substantially within a channel created by interlocking link members 112 of chain assembly 111.

Idler 117 provides a mechanical interface that guides chain assembly 111 around roller frame assembly 115 and provides lateral support for maintaining the position of chain assembly substantially beneath machine 100. For example, when track-type machine 100 is traveling forward the idler 117 associated with the front of roller frame assembly 115 may receive chain assembly 111 from drive sprocket assembly 130, maintaining chain assembly 111 in position for engagement by rollers 118. Similarly, the idler 117 associated with the rear of roller frame assembly 115 may receive chain assembly 111 from rollers 118 beneath roller frame assembly 115 and guide chain assembly 111, thereby maintaining chain position for engagement by drive sprocket assembly 130.

Drive mechanism 120 may include one or more components configured to generate a torque output. For example, drive mechanism 120 may include any suitable type of internal combustion engine, such as a gasoline, diesel, natural gas, or hybrid-powered engine or turbine. Alternatively or additionally, drive mechanism 120 may embody an electric motor, electrically coupled to an electric power source and configured to convert at least a portion of the electrical energy form the electric power output into mechanical energy. According to yet another embodiment, drive mechanism 120 may include a hydraulic motor, fluidly coupled to a hydraulic pump and configured to convert a fluid pressurized by the pump into a torque output.

Drive sprocket assembly 130 may be coupled to drive mechanism 120 and configured to rotate in response to a torque output generated by drive mechanism 120. For example, drive sprocket assembly 130 may be secured (e.g., welded, bolted, heat-coupled, etc.) to a drive hub 121 associated with a shaft (not shown), which may be coupled to drive mechanism 120. During operation of the machine, drive mechanism 120 may rotate the shaft, inducing a corresponding rotation of drive sprocket assembly 130. According to one embodiment, drive sprocket assembly 130 may be directly coupled via a drive shaft to drive mechanism 120. Alternatively, drive sprocket assembly 130 may be coupled to drive mechanism 120 via a torque converter (such as a gearbox, transmission, etc.), so that rotation of drive sprocket assembly 130 may be controlled/adjusted with respect to the torque generated by drive mechanism 120.

Drive sprocket assembly 130 may be adapted to engage a portion of track assembly 110 such that a rotational force applied to the drive sprocket is delivered to the track assembly 110. For example, the drive sprocket assembly 130 may include a plurality of sprocket teeth 150, each of the plurality of sprocket teeth 150 configured to engage a space between adjacent pin members 113 and bushings 114. As drive sprocket assembly 130 turns, teeth 150 of drive sprocket assembly 130 “grab” bushings 114 of chain assembly 111, forcing advancement of chain assembly 111 in the direction of rotation of drive sprocket assembly 130.

Although FIG. 1 is illustrated as a “high-drive” machine (i.e., a machine with an elevated drive system and two idler wheels), it is contemplated that the configurations consistent with the disclosed embodiments may be implemented in any track-type machine. For example, drive sprocket configurations as described herein may be employed in an oval-track machine, where the drive sprocket is located in-line with an idler wheel 117. Thus, the disclosed drive sprocket assembly 130 may be employed in any track-type machine, regardless of the size, type, and configuration of the drive system associated with the machine in which it is employed.

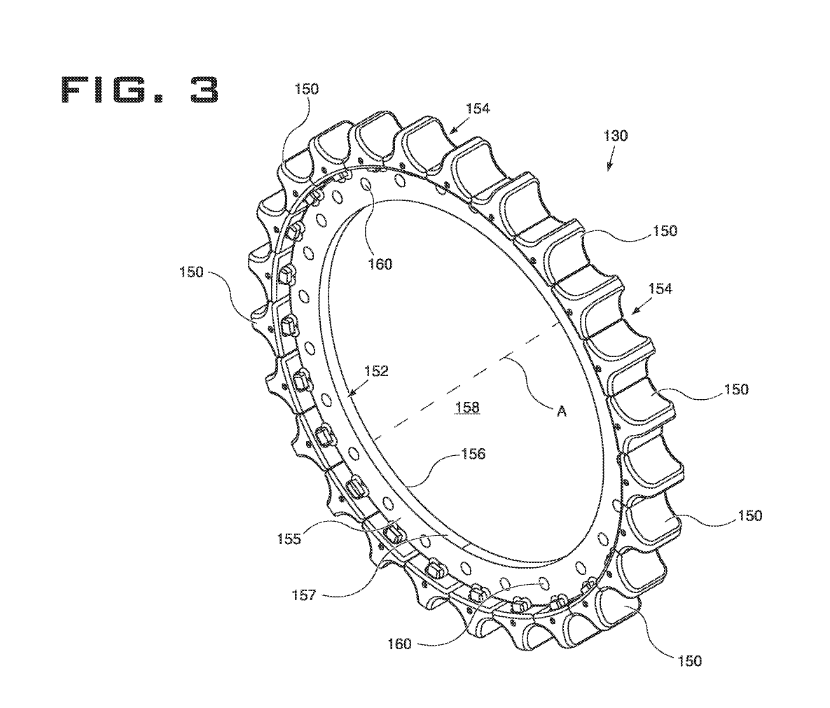

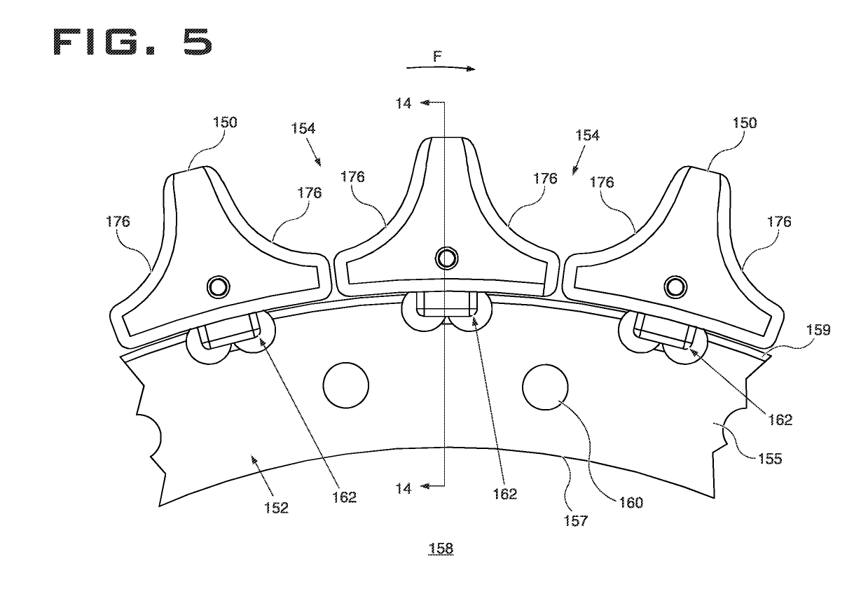

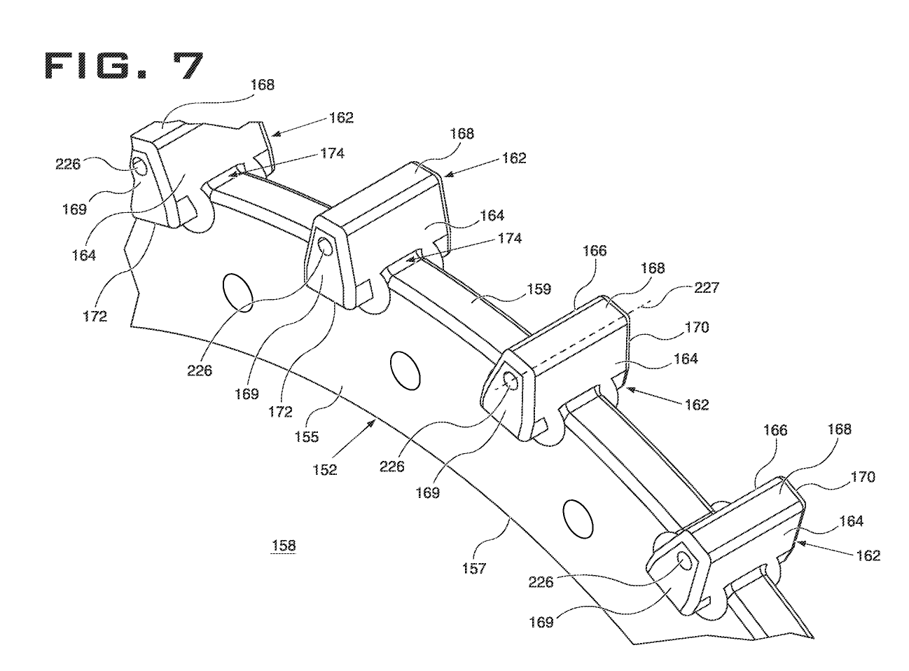

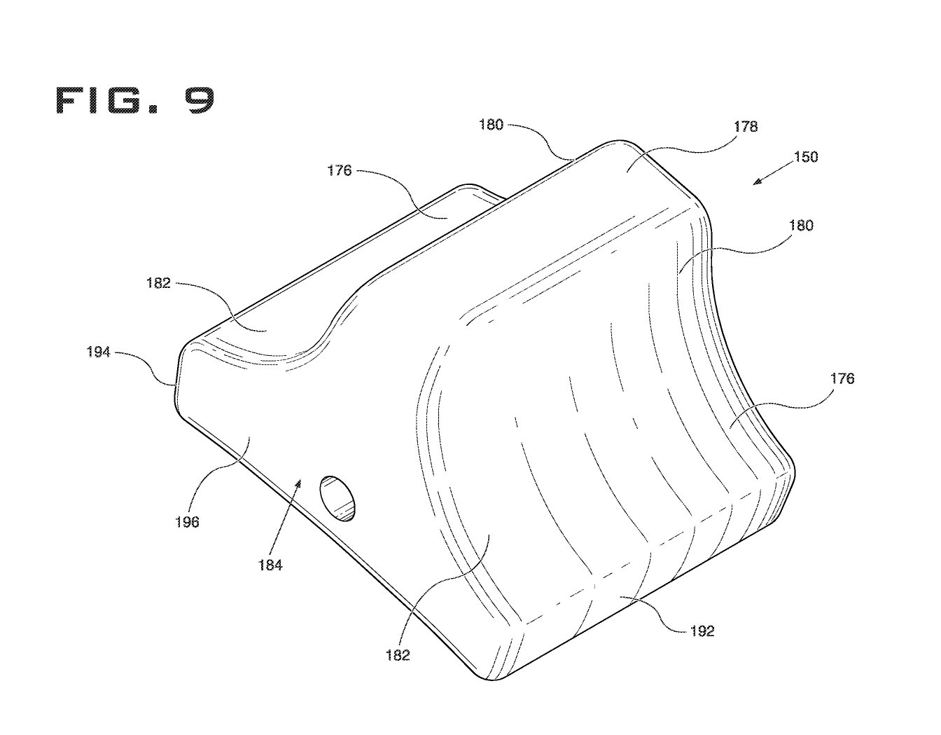

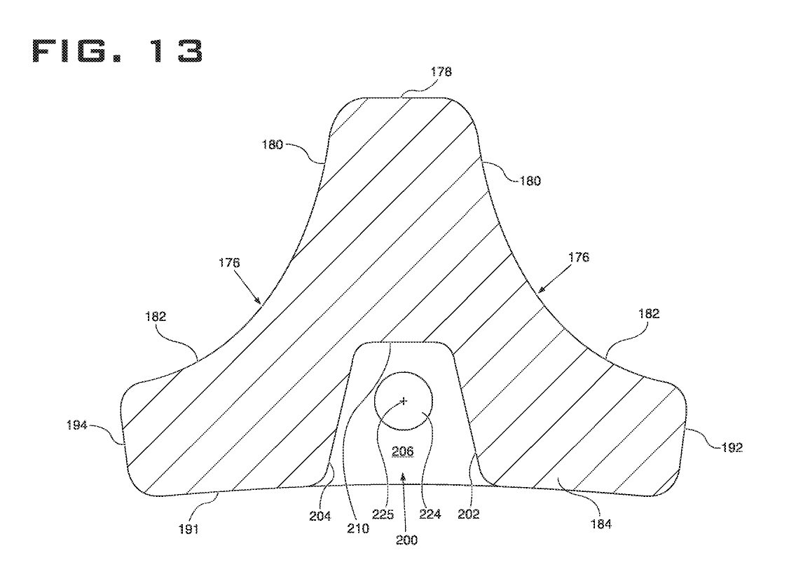

As illustrated in FIGS. 3-15, drive sprocket assembly 130 may include a plurality of teeth 150 extending radially outwardly from a sprocket hub 152. Sprocket teeth 150 may be circumferentially spaced along the outer surface of sprocket hub 152. The exact sizing and spacing of teeth 150 around the outer surface of sprocket hub 152 may vary depending upon the size and application of the sprocket assembly 130. In particular embodiments, the teeth 150 may be approximately equally spaced around the outer circumferential surface of sprocket hub 152 so as to provide intermediate channels 154 of substantially equal sizes. Channels 154 may be configured to receive the pin member 113 and bushing 114 therein, between adjacent sprocket teeth 150, to allow drive sprocket assembly 130 to operatively engage and propel track chain assembly 111.

Sprocket hub 152 may be generally annular in shape with opposing planar surfaces 155 and 156. An inner circumferential surface 157 may extend between the planar surfaces 155 and 156 to define a center bore 158 and an outer circumferential surface 159 may extend between the planar surfaces 155 and 156 to define an outer edge of the sprocket hub 152. Mounting holes 160 may be provided through sprocket hub 152 and may be adapted to receive mounting bolts (not shown) that rotatably secure the sprocket hub 152 to drive hub 121.

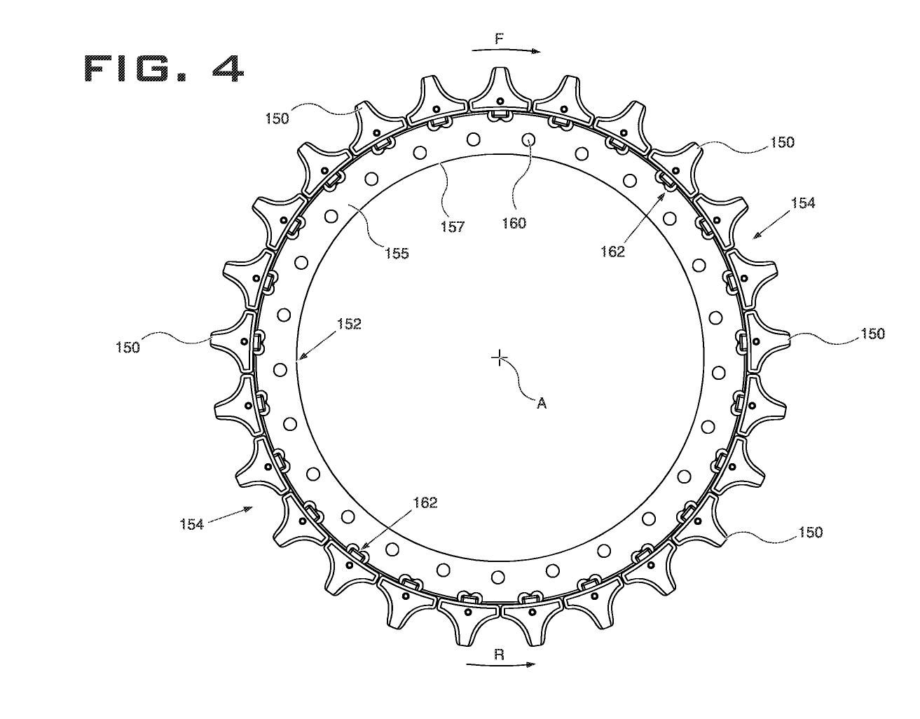

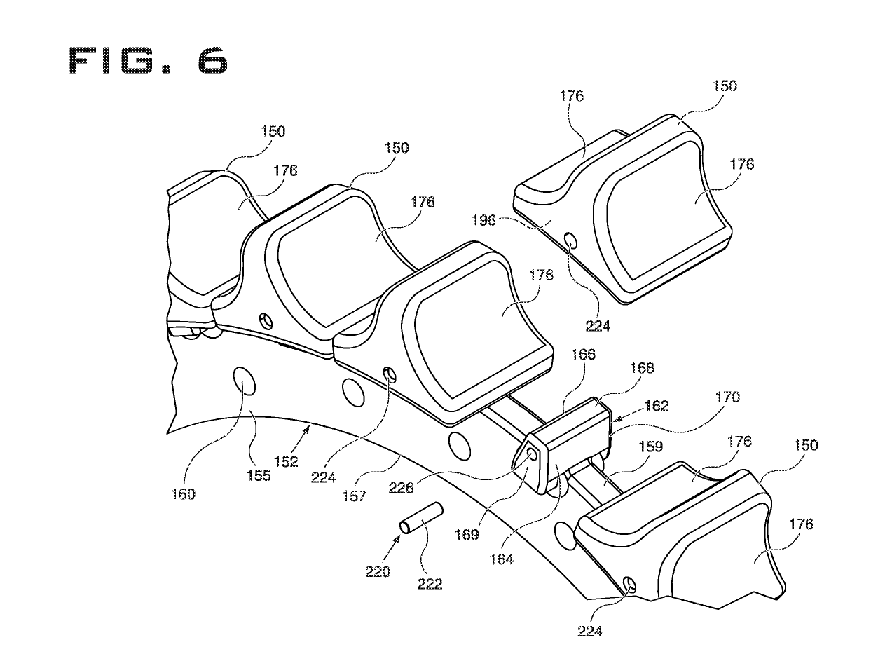

According to the concepts of the present disclosure, the sprocket hub 152 of drive sprocket assembly 130 may further include a plurality of radially extending mounting projections 162 (FIGS. 6-8). Mounting projections 162 may be spaced circumferentially around the outer circumferential surface 159 of sprocket hub 152, each configured to carry and support a sprocket tooth 150 thereon. Accordingly, the angular spacing of the mounting projections 162 around a center axis of rotation A (FIGS. 3-4) is equal to the desired spacing of the sprocket teeth 150. The mounting projections 162 may be formed integrally with the sprocket hub 152 or, alternatively, may be attached to the sprocket hub 152 by any suitable attachment method or mechanism such as, for example, by a weldment.

Each mounting projection 162 may include a front face 164 substantially facing a direction of forward rotation F of the sprocket assembly 130 and a rear face 166 substantially facing a direction of rearward rotation R of the sprocket assembly 130. One or both of the front face 164 and rear face166 may be generally planar and positioned on a plane substantially perpendicular to the planar surfaces 155 and 156 of sprocket hub 152. A top surface 168 of mounting projection 162 may extend between front and rear faces 164 and 166. Opposing side surfaces 169 and 170 may also extend between the front and rear faces 164 and 166. The side surfaces 169 and top surface 168 of mounting projection 162, like the front and rear faces 164 and 166, may be generally planar. A bottom surface 172 may also be substantially planar and extend between the front and rear faces 164 and 166 and side surfaces 169 and 170. A notch 174 may be provided in the bottom surface 172 and front and rear faces 164 and 166 to allow the mounting projection to be received over outer circumferential surface 159 of the sprocket hub 152.

The mounting projection 162 may optionally be tapered to facilitate mounting of a sprocket tooth 150 thereon. Accordingly, the width of the mounting projection 162, which is the distance between the side surfaces 169 and 170, may progressively decrease from bottom surface 172 to top surface 168 along at least a portion of the height of the mounting projection. Similarly, the thickness of the mounting projection, which is the distance between the front and rear faces 164, 166, may progressively decrease from bottom surface 172 to top surface 168 along at least a portion of the height of the mounting projection 162. This tapered shape of the mounting projection 162 may help to facilitate mounting and proper location of the sprocket tooth 150 on the mounting projection 162. Intersections of the various surfaces and/or faces of the mounting projection 162 may be radiused or curved, which may also help to facilitate mounting of the sprocket teeth 150 thereon.

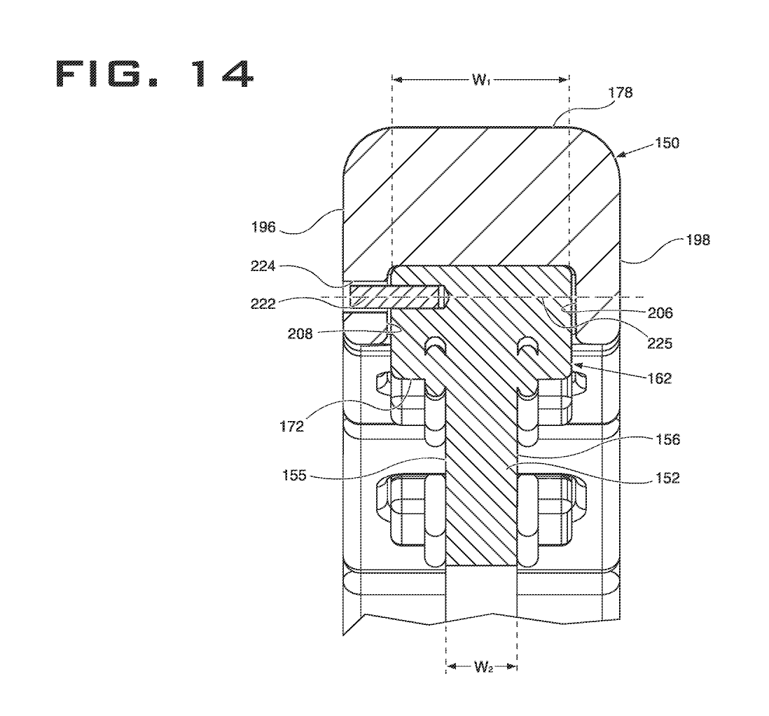

The mounting projection 162 may have a maximum width W₁ that is greater than the width W₂ of the outer circumferential surface 159, as shown in FIG. 14. In a particular embodiment, the mounting projection 162 may have a width W₁ that is greater than 1.5 times the width W₂ of the outer circumferential surface 159.

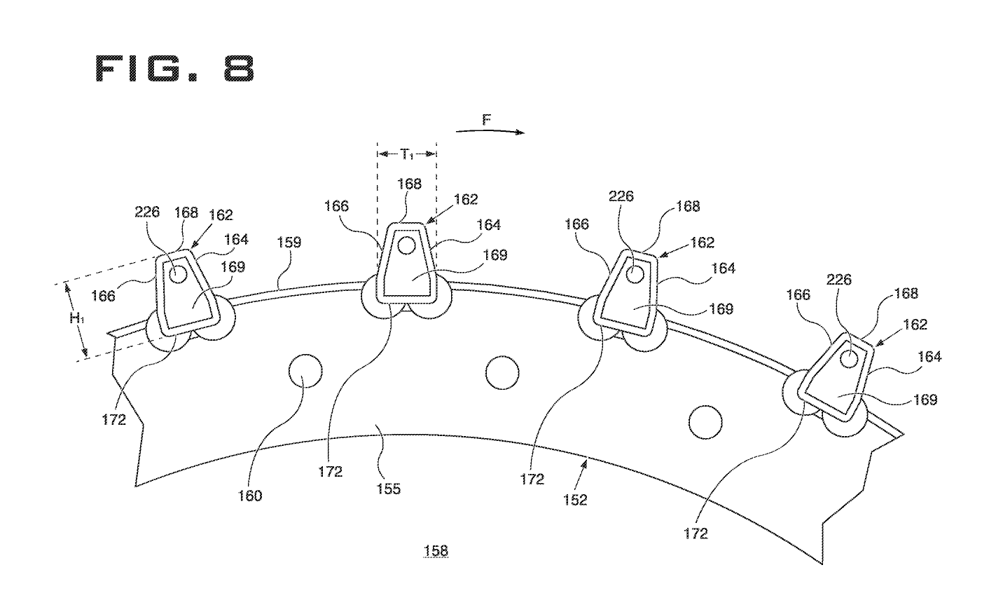

The mounting projection 162 may have a maximum thickness T₁, as shown in FIG. 8, that is greater than the width W₂ of the outer circumferential surface 159. In a particular embodiment, the mounting projection 162 may have a thickness T₁ that greater than 1.2 times the width W₂ of the outer circumferential surface 159.

The mounting projection 162 may have a maximum height H₁, as shown in FIG. 8, that is greater than the width W₂ of the outer circumferential surface 159. In a particular embodiment, the mounting projection 162 may have a height H₁ greater than 2.0 times the width W₂ of the outer circumferential surface 159. The depth of the notch 174 in the bottom surface 172 may account for less than 25% of the total height H₁ of the mounting projection 162.

Each of the plurality of sprocket teeth 150 is both configured to be mounted on a mounting projection 162, and to engage a pin member 113 and/or bushing 114 of a chain assembly 111. In order to provide suitable engagement surfaces for the chain assembly 111, the sprocket tooth 150 includes opposing flank surfaces 176 and an upper surface 178. The flank surfaces 176 may be substantially identical so as to provide a symmetrical sprocket tooth 150. Each of the flank surfaces 176 may face outward from a longitudinal axis L of a center boss 186 that forms the center or peak of a tooth 150, the boss 186 extending generally orthogonally from a base portion 184 of the tooth. Each flank surface may comprise a substantially planar portion 180 adjacent to the upper surface 178 and a substantially convex (i.e., curved) portion 182.

The substantially planar portion 180 of the flank surface 176 may include a portion of the flank surface having a substantially uniform slope. According to an exemplary embodiment, substantially planar portion 180 may be located at or near the top of the tooth 150 where the flank surface 176 interfaces with the upper surface 178. Substantially convex portion 182 may include a surface that complements the rounded shape of bushings 114 associated with pin members 113. The substantially convex portion 182 may be located adjacent to the base 184 of the tooth 150 where the bushing 114 is positioned when received between adjacent teeth 150. When assembled on sprocket hub 152, opposing flank surfaces 176 of adjacent teeth 150 may form a channel 154 for receipt of a bushing 114 associated with a pin member 113.

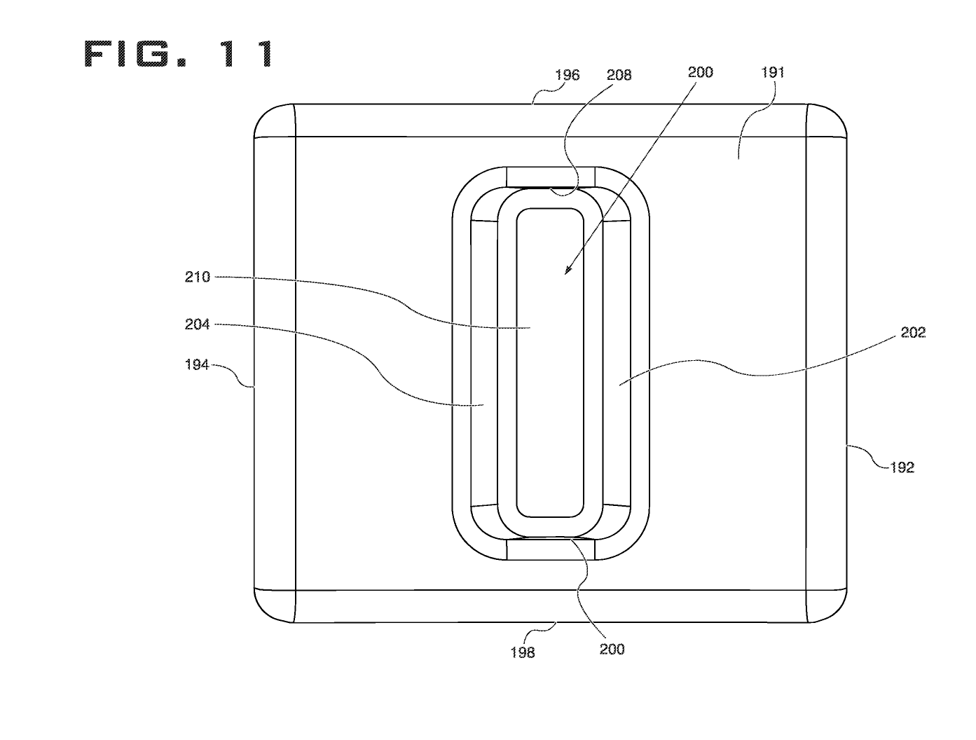

The base 184 of sprocket tooth 150 includes a lower surface 191 (FIG. 11) opposite upper surface 178. Opposing end surfaces 192 and 194 may extend from the lower surface 191 to interface with the convex surface 182 of the opposing flank surfaces 176. Lateral surfaces 196 and 198 extend from the lower surface 191 to the upper surface 178 between the end surfaces 192 and 194 and the flank surfaces 176. Intersections of the various surfaces and/or faces of the sprocket tooth 150 may optionally be curved or beveled for ease of manufacturing, assembly or other considerations.

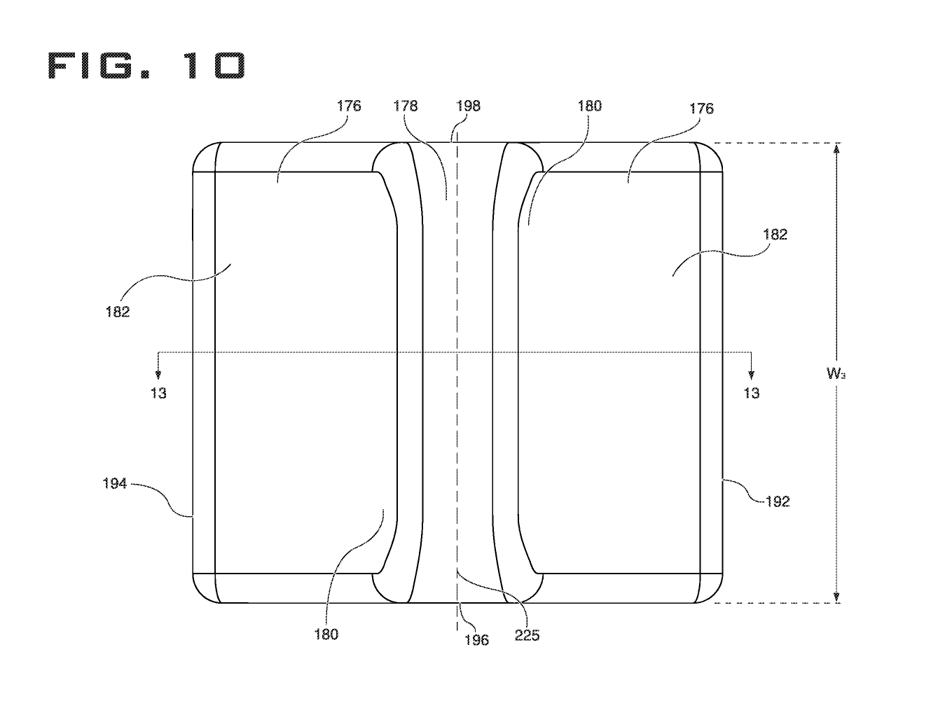

The sprocket tooth 150 may have a maximum width W₃, as shown in FIG. 10, which is the distance between the lateral surfaces 196 and 198 at the widest point of the sprocket tooth 150, that is greater than the maximum width W₁ of the mounting projection 162. In a particular embodiment, the sprocket tooth 150 may have a maximum width W₃ that is greater than 1.5 times the maximum width W₁ of the mounting projection 162.

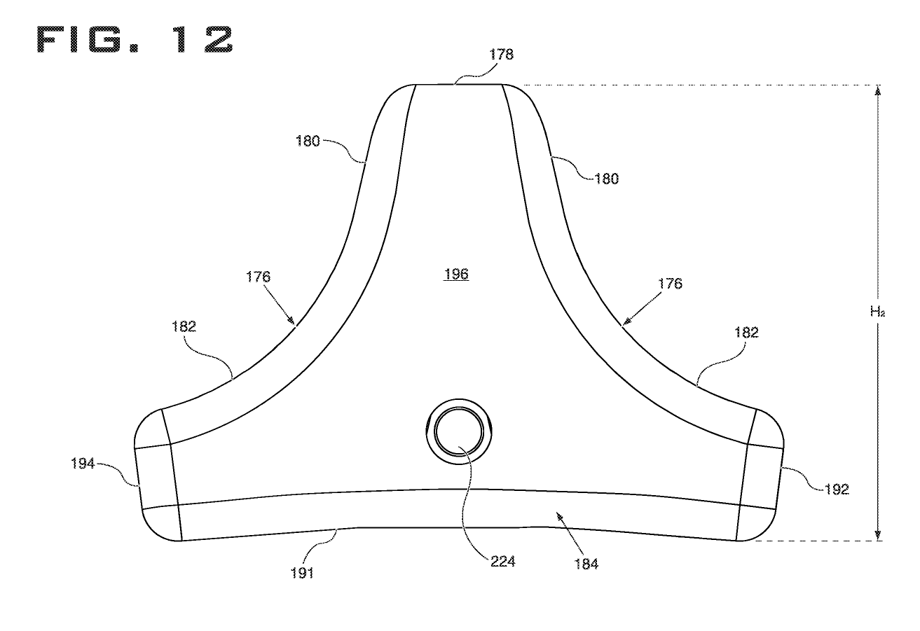

The sprocket tooth 150 may have a height H₂, as shown in FIG. 12, which is the distance between the lower surface 191 and the upper surface 178, that is greater than the height H₁ of the mounting projection 162. In a particular embodiment, the sprocket tooth 150 may have a height H₂ greater than 1.5 times the height H₁ of the mounting projection 162.

Lower surface 191 may include a recess portion 200 that defines a recess 201 configured to receive a mounting projection 162 therein. The recess portion 200 may therefore be sized and shaped to correspond to the size and shape of the mounting projection 162. Accordingly, recess portion 200 may include a first face 202 oriented to generally face end surface 192 and a second face 204 oriented to generally face end surface 194. Side surfaces 206 and 208 may span the distance between first face 202 and second face 204, and an innermost surface 210 may define a distal end to recess portion 200. Recess portion 200 may define a recess 201 that has a complimentary taper with respect to mounting projection 162.

The dimensions and orientation of the various surfaces 202, 204, 206, 208 and 210 of recess portion 200 may be configured to mate and engage substantially all of the surface area of the outer surfaces 164, 166, 168, 169 and 170 of the mounting projection 162 when a sprocket tooth 150 is positioned on a mounting projection 162. Thus, the corresponding geometries of the mounting projection 162 and recess portion 200 and the respective taper of each component may provide for an intimate engagement between the sprocket tooth 150 and mounting projection 162.

A retention mechanism 220 may be provided to releasably secure each sprocket tooth 150 to a mounting projection 162. It is contemplated that the retention mechanism may be any selectively releasable mechanism known to those skilled in the art and suitable for the intended purpose and function. One example of a known retention mechanism 220 is a set screw received in threaded holes in the sprocket tooth 150 and/or mounting projection 162. However, other retention mechanisms 220 will be apparent to those skilled in the art and may be incorporated into the drive sprocket assembly 130 without deviating from the scope of the present disclosure.

In an exemplary embodiment, as shown in FIGS. 6 and 14, the retention mechanism 220 includes a retention pin 222 that is received in a pin bore 224 in the lateral surface 196 of sprocket tooth 150 and a pin bore 226 in the mounting projection 162. The pin bore 224 in the lateral surface 196 of the base 184 may be positioned on an insertion axis 225 oriented generally perpendicular to the lateral surfaces 196 and 198. Similarly, the pin bore 226 in the mounting projection 162 may extend through the mounting projection between the side surfaces 169 and 170 on an insertion axis 227 oriented generally perpendicular to the side surfaces 169 and 170.

When the sprocket tooth 150 is positioned on a mounting projection 162, the pin bore 224 in the sprocket tooth 150 may align with the pin bore 226 in the mounting projection 162. The retention pin 222 may then be positioned in the pin bores 224 and 226 to secure the sprocket tooth 150 against any substantial movement relative to the mounting projection 162. In a particular embodiment, the retention pin 222 may be press fit into pin bore 226 and/or pin bore 224. While the retention pin 222 is shown as extending only partially through mounting projection 162, it is also contemplated that pin bores 224 and 226 may be provided to accommodate a retention pin 222 that extends the entire width of mounting projection 162 and is retained on each end. For example, one end of a retention pin 222 in such an embodiment may include a head having an enlarged diameter, and the other end may be configured to receive a cotter pin.

### INDUSTRIAL APPLICABILITY

The drive sprocket assembly of the present disclosure may be employed in any track-type vehicle that utilizes a sprocketed drive assembly. Conventional drive sprockets may include a plurality of interconnected sprocket segments, each segment including a portion of the sprocket flange that connects to the final drive of the vehicle, a portion of the sprocket rim, and a plurality of teeth. These sprocket segments are connected to the final drive of the vehicle by a plurality of bolts passing through mounting holes in the flange. The bolted joints of the sprocket segments may require special tightening procedures and may be subject to variables that increase the likelihood of failure of the bolted joint. In addition, the tight tolerances of the bolted joint may make manufacturing challenging. In addition, a large portion of the sprocket may be discarded when a sprocket segment is replaced due to tooth wear.

The drive sprocket assembly 130 of the present disclosure, including individually removable and replaceable teeth, may provide an improvement over conventional drive sprockets. The teeth 150 of the drive sprocket assembly 130 are individually replaceable, thereby removing the necessity of repeated disassembly and reassembly of the final drive mounting bolts. In addition, only the sprocket teeth 150 are replaced due to wear, which may minimize the amount of discarded material. Furthermore, the sprocket teeth 150 may be easily removed and replaced without disassembly of the chain assembly 111.

Drive sprocket assembly 130 may also provide improved strength and reliability as compared to previously contemplated drive sprockets with individually removable sprocket teeth. Mounting the sprocket tooth 150 onto the mounting projection 162 using recess portion 200 causes the high tangential forces acting on the sprocket teeth 150 to be transferred to the sprocket hub 152 directly through the mounting projection 162 rather than through the retention device. The strength and reliability of the drive sprocket assembly 130 may be further increased by maximizing the contact surface area between the mounting projection 162 and the recess portion 200, particularly on the forward and rearward surfaces of the mounting projection 162. The increased contact surface area on the sides facing the directions of rotation of the sprocket assembly 130 may help to distribute forces across a wider area.

In a drive sprocket assembly 130 as described herein, the retention mechanism 220 needs only to retain the sprocket tooth 150 against radial movement relative to the mounting projection 162. The retention mechanism is not subjected to the high tangential loads that act upon the sprocket tooth 150 during operation of the track assembly 110 because those forces are primarily transferred from the sprocket tooth 150 to the mounting projection 162. This type of sprocket tooth mounting mechanism may improve the strength and reliability of the drive sprocket assembly 130 relative to known designs.

Replacement of a worn sprocket tooth 150 may be accomplished by first releasing, unlocking or otherwise disabling the retention mechanism 220 to allow removal of a worn sprocket tooth 150. In the embodiment including the retention pin 222, releasing the retention mechanism 220 would include removing the pin from the pin bores 224 and 226 in the sprocket tooth 150 and mounting projection 162, respectively. Removal of the pin 222 allows the sprocket tooth 150 to be moved radially relative to the mounting projection 162.

Once the retention mechanism has been released the worn sprocket tooth 150 may be removed from the mounting projection 162 and a new sprocket tooth 150 may be mounted over the mounting projection 162. The new sprocket tooth may have an internal recess portion that is adapted to receive the mounting projection 162 therein. The retention mechanism 220 may then be activated to prevent radial movement of the new sprocket tooth 150 relative to the mounting projection 162. Notably, replacement of a worn sprocket tooth 150 with a new sprocket tooth 150 may be accomplished while the drive sprocket assembly 130 remains mounted to the drive mechanism 120, thereby allowing for reduced downtime while servicing the drive sprocket assembly 130.

It will be apparent to those skilled in the art that various modifications and variations can be made to the drive sprocket assembly of the present disclosure without departing from the scope of the disclosure. Other embodiments will be apparent to those skilled in the art from consideration of the specification. It is intended that the specification and examples be considered as exemplary only, with a true scope of the disclosure being indicated by the following claims and their equivalent.

What is claimed is:

1. A sprocket assembly comprising:
a hub;
a plurality of circumferentially spaced projections extending radially outward from the hub; and
a plurality of teeth, each tooth being carried by one of the projections and having a recess that receives said projection therein.

2. The sprocket assembly of claim 1, further comprising:
a retention mechanism for releasably securing each tooth to one of the projections.

3. The sprocket assembly of claim 1, wherein each of said teeth define a first hole and each of said projections define a second hole, and wherein the retention mechanism is adapted to cooperate with said first and second holes in said plurality of teeth and projections to secure each tooth to one of the projections.

4. The sprocket assembly of claim 1, wherein the projections each have a front face generally facing a forward direction of rotation of the sprocket assembly, a rear face opposite the front face and generally facing a rearward direction of rotation, opposing side surfaces extending between the front and rear faces, a top surface facing radially outward, and a bottom surface facing radially inward.

5. The sprocket assembly of claim 4, wherein a distance between the front and rear faces adjacent the bottom surface is greater than a distance between the front and rear faces adjacent the top surface.

6. The sprocket assembly of claim 4, wherein the recess in each tooth is defined by a recess portion having a first face generally facing the rearward direction of rotation of the sprocket assembly, a second face generally facing the forward direction of rotation, and opposing side surfaces extending between the first face and the second face.

7. The sprocket assembly of claim 6, wherein the first face is in contact with the front face of the projection when the sprocket tooth is mounted on the projection.

8. The sprocket assembly of claim 1, wherein each of said plurality of projections has an axial width W₁ that is greater than an axial width W₂ of the hub.

9. The sprocket assembly of claim 1, wherein each of said plurality of projections has an axial width W₁ that is at least 1.5 times a axial width W₂ of the hub.

10. A sprocket tooth comprising:
a base including a lower surface;
a boss extending from the base and having a longitudinal axis;
first and second flank surfaces, each flank surface facing generally outward from the longitudinal axis of the boss; and
a recess portion extending from the lower surface of the base and defining a recess, the recess portion configured to receive a projection extending from a hub.

11. The sprocket tooth of claim 10, wherein the first and second flank surfaces each include a substantially convex portion and a substantially planar portion.

12. The sprocket tooth of claim 10, wherein a top surface extends between the opposing flank surfaces opposite the lower surface of the base.

13. The sprocket tooth of claim 10, further comprising:
opposing end surfaces extending upwardly from the lower surface of the base, each of the end surfaces terminating at one of the first and second flank surfaces, and
opposing lateral surfaces extending upwardly from the lower surface, between the opposing end surfaces, and between the first and second flank surfaces.

14. The sprocket tooth of claim 13, wherein one of said lateral surfaces defines a hole for receipt of a retaining mechanism, the hole providing access to the recess portion of the tooth.

15. The sprocket tooth of claim 10, wherein the recess portion includes a first face generally facing toward the longitudinal axis of the boss.

16. The sprocket tooth of claim 15, wherein the recess portion includes a second face, opposing side surfaces extending between the first face and the second face, and an innermost surface.

17. The sprocket tooth of claim 16, wherein a distance between the first and second faces of the recess portion progressively decreases approaching the innermost surface.

18. A method of replacing a tooth on a sprocket comprising the steps of:
releasing a retaining mechanism to allow removal of a worn tooth having an internal recess from a projection extending radially outward from a hub;
removing the worn tooth from the projection;
positioning a new tooth having an internal recess over the projection so that the projection is received within the recess; and
activating the retaining mechanism to prevent removal of the new tooth from the projection.
